(19) United States
(12) Patent Application Publication
(10) Pub. No.: US 2010/0022171 A1
(43) Pub. Date: Jan. 28, 2010

(54) Glass polishing compositions and methods

(76) Inventors: Nevin Naguib, Aurora, IL (US); Kevin Moeggenborg, Naperville, IL (US)

Correspondence Address: STEVEN WESEMAN;ASSOCIATE GENERAL COUNSEL, I.P., CABOT MICROELECTRONICS CORPORATION, 870 NORTH COMMONS DRIVE, AURORA, IL, 60504, US

(21) Appl. No.: 12/311,717

(22) PCT Filed: Oct. 16, 2007
(86) PCT No.: PCT/US07/22014

§ 371 Date: Apr. 9, 2009

Related U.S. Application Data
(60) Provisional application No. 60/852,451, filed on Oct. 16, 2006.
(60) Provisional application No. 60/930,399, filed on May 16, 2007.

(51) Int. Cl. B24B 7/24; C09K 3/14

(52) U.S. Cl. 451/41; 51/298

(57) ABSTRACT

The present invention provides glass polishing compositions and methods suitable for polishing a glass substrate at a down force of about 110 g/cm² or less. One preferred polishing composition comprises a particulate cerium oxide abrasive (e.g., about 1 to about 15 percent by weight) suspended in an aqueous carrier containing a polymeric stabilizer, e.g., about 50 to about 1500 ppm of the stabilizer, and optionally, a water soluble inorganic salt. Preferably, the particulate cerium oxide abrasive has a mean particle size in the range of about 0.35 to about 0.9 μm. Another preferred composition comprises about 1 to about 15 percent by weight of a particulate cerium oxide abrasive characterized by a mean particle size of at least about 0.2 μm and a purity of at least about 99.9% CeO², on a weight basis, suspended in an aqueous carrier at a pH at least about 1 unit higher or lower than the isoelectric point (IEP) of the cerium oxide abrasive.

### CROSS-REFERENCE TO RELATED APPLICATIONS

This application claims the benefit of U.S. Provisional Application for Patent Ser. No. 60/852,451, filed on Oct. 16, 2006, and U.S. Provisional Application for Patent Ser. No. 60/930,399, filed on May 16, 2007, which are incorporated herein by reference.

### FIELD OF THE INVENTION

This invention relates to compositions and methods for polishing a glass substrate. More particularly, this invention relates to the use of cerium oxide polishing compositions for polishing glass surfaces.

### BACKGROUND OF THE INVENTION

Liquid crystal display (LCD) and organic light emitting diode (OLED) flat panel devices typically include a thin glass panel over the outer display surface of the LCD or OLED cell structure. It is desirable for this panel to be thin and highly uniform, in order to minimize the weight of the panel, and to provide superior optical properties. OLED and LCD-grade glasses include soda lime and alkaline earth metal oxide-Al₂O₃—SiO₂ glasses, such as EAGLE®2000 glass, EAGLE®XL glass, and 1737 glass, and the like, which are available from Corning Inc., Corning, N.Y. Preferably, the alkaline earth metal oxide component of the glass comprises one or more oxide selected from MgO, CaO, SrO, and BaO.

Conventional systems for glass panel polishing typically utilize a two-step process involving an initial lapping or etching step to remove the bulk of the material (the bulk removal step), followed by a buffing or polishing step utilizing a polishing composition comprising relatively large particles of cerium oxide (e.g., mean particle size of about 2 micron or larger) mixed with water, and used in combination with a fixed-abrasive pad or tape. The buffing or polishing step is used mainly to remove damage (e.g., pits, scratches, and the like) created by the bulk removal step. These conventional polishing systems are not entirely satisfactory for polishing glass surfaces for flat panel displays due to the relatively low glass removal rates obtained with such systems, e.g., removal rates of less than about 500 nanometers-per-minute (nm/min; 0.5 μm/min). These low removal rates can not effectively eliminate the pits and scratches created by the bulk removal step in a timely manner. Also, the relatively large cerium oxide particles tend to form macro-scratches and pitting on the glass surface. Surface scratches and pitting degrade the optical properties of the panel. In addition, the large cerium oxide particles tend to settle out from the water in transfer lines and slurry reservoirs, which leads to manufacturing difficulties.

In many conventional polishing techniques, a substrate carrier or polishing head is mounted on a carrier assembly and positioned in contact with a polishing pad in a polishing apparatus. The carrier assembly provides a controllable pressure (down force) to the substrate, urging the substrate against the polishing pad. The pad is moved relative to the substrate by an external driving force. The relative movement of the pad and substrate serves to abrade the surface of the substrate to remove a portion of the material from the substrate surface, thereby polishing the surface. Polishing typically is further aided by the chemical activity of the polishing composition and/or the mechanical activity of the abrasive suspended in the polishing composition. In typical glass polishing systems, as described above, a relatively high down force of greater than about 110 grams-per-square centimeter (g/cm²; about 1.56 pounds-per-square inch, psi) must be used to obtain useful removal rates. Such high down forces increase the breakage rate for the relatively thin glass panels used in LCD and OLED devices.

There is an ongoing need to develop polishing compositions that are capable of polishing glass, particularly OLED and LCD-grade glass panels, utilizing a down force of about 110 g/cm² or less and having improved slurry handling characteristics relative to conventional cerium oxide polishing slurries. Lower down forces reduce the amount of glass breakage during polishing relative to convention polishing methods. There is also a need for polishing slurries that provide an improved glass removal rate relative to the commonly used large particle cerium oxide buffing systems (i.e., removal rates greater than 500 nm/min). The present invention provides such compositions. These and other advantages of the invention, as well as additional inventive features, will be apparent from the description of the invention provided herein.

### BRIEF SUMMARY OF THE INVENTION

In one aspect, the present invention provides glass polishing compositions and methods suitable for polishing glass, particularly OLED and LCD-grade glass panels, utilizing a down force of about 110 g/cm² or less. A preferred aqueous glass polishing composition of the present invention comprises a particulate cerium oxide abrasive suspended in an aqueous carrier containing a stabilizer, and optionally a water soluble inorganic salt (e.g., a cesium halide). In a preferred embodiment the composition comprises a particulate cerium oxide abrasive having a mean particle size in the range of about 350 nm to about 900 nm (0.35 μm to 0.9 μm) suspended in an aqueous carrier with the aid of a polymeric stabilizer. Preferably, the stabilizer comprises at least one acidic polymer selected from the group consisting of a polyacrylate (e.g., polyacrylic acid), a polymethacrylate (e.g., polymethacrylic acid), and a poly(vinyl sulfonate) (e.g., poly(vinylsulfonic acid), which can be present in the polishing composition in the acid form, a salt form (e.g., an alkali metal salt), or a partially neutralized form. In another embodiment, the composition comprises at least one polar, non-ionic or anionic polymer selected from the group consisting of a polyvinylpyrrolidone (PVP), a poly(vinyl alcohol), a poly(2-ethyloxazoline), a hydroxyethyl cellulose, and a xanthan gum. Preferably, the ceria abrasive comprises at least about 99.9% CeO₂ on a weight basis.

In another aspect, a glass polishing composition of the invention comprises a about 1 to about 15 percent by weight of a particulate cerium oxide abrasive having a purity of at least about 99.9% CeO₂, on a weight basis, suspended in an aqueous carrier. The cerium oxide abrasive has a mean particle size of at least about 0.2 μm, preferably in the range of about 0.2 to about 11 μm, and a pH at least about 1 unit higher or lower than the isoelectric point (IEP) of the cerium oxide abrasive. Typically the IEP of cerium oxide is at a pH value in the range of about 6 to about 7. In one preferred embodiment, the composition has a pH in the range of about 3 to about 4, and can optionally comprise about 1 to about 20 parts-per-million (ppm; preferably about 5 to 10 ppm) of picolinic acid (i.e., pyridine-2-carboxylic acid) as a stabilizer. The presence of picolinic acid is particularly preferred when utilizing the abrasive at about 1 percent by weight concentration. In another preferred embodiment, the composition has a pH in the range of about 8 to about 9.

The compositions and methods of the present invention provide relatively high glass removal rates of greater than about 500 nm/min when utilized for polishing glass, particularly OLED and LCD-grade glass panels, such as soda lime glass and alkaline earth metal oxide-Al₂O₃—SiO₂ glass panels. The compositions and methods of the present invention desirably are readily adaptable to large scale application. One advantage of stabilized glass polishing compositions of the invention is improved handling characteristics (i.e., less settling of the cerium oxide particles in delivery lines and in the slurry reservoir tank), and improved recyclability.

A preferred method embodiment comprises the steps of contacting a surface of the substrate with a polishing pad and an aqueous glass polishing composition of the present invention and causing relative motion between the polishing pad and the substrate while maintaining at least a portion of the composition in contact with the surface between the pad and the substrate for a time period sufficient to abrade at least a portion of the glass from the surface.

### BRIEF DESCRIPTION OF THE DRAWINGS

FIG. 1 shows a bar graph of glass removal rate (RR in μm/min) obtained by polishing a glass panel according to the methods of the invention utilizing polishing compositions comprising cerium oxide and PVP, with and without added cesium chloride, compared to results achieved using a composition containing cerium oxide alone.

FIG. 2 shows a graph of glass removal rate (RR in μm/min) obtained by polishing a glass panel according to the methods of the invention utilizing polishing compositions comprising cerium oxide and polymethacrylate compared to the results obtained using a composition containing only the cerium oxide.

### DETAILED DESCRIPTION OF THE INVENTION

The present invention provides glass polishing compositions and methods suitable for polishing glass panels used in LCD and OLED displays, particularly at a down force of about 10 g/cm² or less. In a first aspect, the glass polishing composition comprises cerium oxide particles suspended in an aqueous carrier through the aid of a polymeric stabilizer. In some preferred embodiments, the composition also comprises a water soluble inorganic salt.

The polymeric stabilizer can be any substance that provides a stable suspension of cerium oxide particles. Non-limiting examples of suitable stabilizers include acidic polymers (e.g., acrylic acid polymers, methacrylic acid polymers, and vinyl sulfonic acid polymers), polar, nonionic polymers (e.g., vinylpyrrolidone polymers, vinyl alcohol polymers, 2-ethyloxazoline polymers, hydroxyalkyl cellulose), and anionic polysaccharides (xanthan gums). In one preferred embodiment, the stabilizer comprises at least one polymer selected from the group consisting of a polyacrylic acid, a polymethacrylic acid, and a poly(vinyl sulfonic acid), which can be in an acid, salt, or a partially neutralized form. In another preferred embodiment, the stabilizer comprises at least one polymer selected from the group consisting of a polyvinylpyrrolidone (PVP), a poly(vinyl alcohol), a poly (2-ethyloxazoline), a hydroxyethyl cellulose, and a xanthan gum.

For convenience, the terms “acrylate”, “polyacrylate”, “methacrylate”, “polymethacrylate”, “sulfonate” and “poly(vinyl sulfonate)” refer to the acid forms, the salt forms, and to partially neutralized forms thereof. Preferably, the stabilizer is present in the composition in an amount in the range of about 50 to about 1500 parts-per-million (ppm), on an actives basis, more preferably about 100 to about 1000 ppm.

When a polyacrylate, a polymethacrylate, and/or a polyvinyl sulfonate is utilized as a stabilizer in the methods of the present invention, the stabilizer preferably has a molecular weight in the range of about 3,000 to about 40,000 grams-per-mole (g/mol). Unless otherwise specified, molecular weights for stabilizers are weight average molecular weights (M_{w}) as determined by solution property techniques, such as intrinsic viscosity and/or gel permeation chromatography (GPC). When a PVP is utilized as the stabilizer, the PVP preferably has a molecular weight in the range of about 30,000 to about 1,000,000 g/mol, as indicated by the so-called K-value, which is preferably in the range of about 25 to about 90. When a poly(vinyl alcohol) is utilized as the stabilizer, the poly(vinyl alcohol) preferably has a molecular weight in the range of about 12,000 to about 200,000 g/mol. When a poly(2-ethyloxazoline) is utilized as the stabilizer, the poly(2-ethyloxazoline) preferably has a molecular weight in the range of about 50,000 to about 500,000 g/mol. The above polymers are believed to increase the colloidal stability of the particles in the polishing compositions by keeping the cerium oxide particles from coming together and flocculating in the slurry.

The water soluble inorganic salt, when present, preferably comprises about 0.05 to about 0.1 percent by weight of the polishing composition, based on the total weight of the composition, more preferably about 0.1 percent by weight. Preferred inorganic salts include water soluble cesium salts, such as cesium halides (e.g., cesium chloride). A particularly preferred water soluble inorganic salt is cesium chloride.

Without wishing to be bound by theory, it is believed that water soluble inorganic salts, such as cesium chloride, provide a relatively high ionic strength, which increases the friction force between the cerium oxide particles and the glass surface, thus beneficially increasing the glass removal rate.

The cerium oxide abrasive used in this first aspect of the invention preferably has a mean particle size in the range of about 350 nm to about 900 nm, more preferably about 450 nm to about 500 nm, as determined by laser light scattering techniques, which are well known in the art. Preferably, the cerium oxide abrasive is present in the polishing composition in amount in the range of about 1 to about 15 percent by weight, more preferably about 5 to about 10, based on the total weight of the composition.

The polishing compositions of the first aspect of the invention can have any pH that is compatible with the components of the composition and that is suitable for glass polishing applications. In some embodiments, such as when PVP is utilized as the stabilizer, the pH is preferably mildly acidic (e.g., about 4 to about 6). In other embodiments, the pH of the composition is in the neutral to basic range, e.g., in the range of about 7 to about 11, more preferably about 7 to about 9.

In a second aspect, a glass polishing composition of the invention comprises about 1 to about 15 percent by weight of a particulate cerium oxide abrasive having a purity of at least about 99.9% CeO₂, on a weight basis, suspended in an aqueous carrier. In this second aspect of the invention, the cerium oxide abrasive has a mean particle size of at least about 0.2 μm, preferably in the range of about 0.2 to about 11 μm, and a pH at least about 1 unit higher or lower than the isoelectric point (IEP) of the cerium oxide abrasive. Typically the IEP of cerium oxide is at a pH value in the range of about 6 to about 7.

Conventionally, cerium oxide abrasives are typically utilized at a pH at or near the IEP (pH 6-7) for polishing glass. Surprisingly, we have discovered that cerium oxide having a purity of at least about 99.9% by weight CeO₂ (“ultra pure” cerium oxide), and a mean particle size of at least about 0.2 μm, preferably about 0.2 to about 11 μm, provides significantly higher glass removal rates for polishing LCD grade glasses when utilized at a pH at least about 1 unit higher or lower than the IEP.

In one preferred embodiment, the composition of the second aspect has a pH in the range of about 3 to about 4, and can optionally comprise about 1 to about 20 parts-per-million (ppm; preferably about 5 to 10 ppm) of picolinic acid as a stabilizer. The presence of picolinic acid is particularly preferred when utilizing the abrasive at lower concentrations (e.g., about 1 percent by weight concentration). In another preferred embodiment of the second aspect, the composition has a pH in the range of about 8 to about 9.

The cerium oxide abrasive in the compositions of the invention desirably is suspended in the aqueous component of the polishing composition, preferably in a colloidally stable state. The term “colloid” refers to the suspension of abrasive particles in the liquid carrier. “Colloidal stability” refers to the maintenance of that suspension over time with minimal settling of the particles. In the context of this invention, a particulate abrasive is considered colloidally stable if, when the abrasive is placed into a 100 mL graduated cylinder and allowed to stand without agitation for a period of time of about 2 hours, the difference between the concentration of particles in the bottom 50 mL of the graduated cylinder ([B] in terms of g/mL) and the concentration of particles in the top 50 mL of the graduated cylinder ([T] in terms of g/mL) divided by the initial concentration of particles in the composition ([α] in terms of g/mL) is less than or equal to 0.5 (i.e., ([B]-[T])/[α]≦0.5). The value of ([B]-[T])/[C] desirably is less than or equal to 0.3, and preferably is less than or equal to 0.1.

The aqueous carrier for the compositions of the invention can be any aqueous liquid suitable for use in a glass polishing process. Such compositions include water, aqueous alcohol solutions, and the like. Preferably, the aqueous carrier comprises deionized water.

The compositions of the invention optionally can comprise one or more additives, such as a surfactant, a biocide, and the like.

The polishing compositions of the invention can be prepared by any suitable technique, many of which are known to those skilled in the art. For example, the composition can be prepared in a batch or continuous process. Generally, the composition can be prepared by combining the components thereof in any order. The term “component” as used herein includes individual ingredients (e.g., abrasive, stabilizer, water soluble inorganic salt, acids, bases, and the like) as well as any combination of ingredients. For example, the water soluble inorganic salt and stabilizer can be dissolved in water, the abrasive can be dispersed to the resulting solution, and any other components can then be added and mixed by any method that is capable of uniformly incorporating the components into the composition. The pH can be adjusted at any suitable time, if needed. The pH of the composition can be adjusted with any suitable acid, base, or buffering agent, as needed. Suitable pH adjusters include, without limitation, potassium hydroxide, ammonium hydroxide, and nitric acid.

The compositions also can be provided as a concentrate, which is intended to be diluted with an appropriate amount of water prior to use. In such an embodiment, the composition concentrate can comprise the cerium oxide abrasive, stabilizer, water soluble inorganic salt, and any other components dispersed and/or dissolved in an aqueous carrier in amounts such that, upon dilution of the concentrate with an appropriate amount of aqueous solvent, each component of the polishing composition will be present in the glass polishing composition in an amount within the appropriate range for use.

The compositions of the invention can be incorporated in a single preformulated composition, which comprises the cerium oxide abrasive dispersed in an aqueous carrier that includes at least one stabilizer compound, an optional inorganic salt, and other optional ingredients, if desired, at the desired pH. Alternatively, the compositions can be provided in a two-part form (i.e., a two-part article of manufacture) to avoid potential changes in the activity of the slurry over time. Such two-part articles of manufacture include a first container comprising at least the stabilizer with an optional inorganic salt, and a second container, which includes a cerium oxide particulate abrasive in dry form or preferably as a slurry in an aqueous carrier (e.g., deionized water). The first and second containers are packaged together, preferably along with instructions for mixing the contents of the containers to form a composition of the invention. The pH of the aqueous carriers and the concentrations of the various components in each package can be selected so that upon mixing of the contents of the first container with the contents of the second container, a polishing composition suitable for use in the methods of the present invention is provided, e.g., having a suitable amount of cerium oxide (e.g., about 1 to 15 percent by weight) suspended in the aqueous carrier at a suitable pH (e.g., about 7 to about 11) and containing a suitable amount of stabilizer (e.g., about 50 to about 1500 ppm) and optional components.

In a preferred embodiment, the two-part article of manufacture comprises a first container, which includes at least one stabilizer dissolved in a first aqueous carrier, and which is packaged together with a second container including a particulate cerium oxide abrasive, preferably suspended in a second aqueous carrier. The cerium oxide abrasive is characterized by a mean particle size in the range of about 350 to about 900 nm, and the stabilizer is selected from the group consisting of a polyacrylate, a polymethacrylate, a poly(vinyl sulfonate), and a salt of any of the foregoing. Upon mixing the contents of the first container with the contents of the second container, a polishing composition of the invention is formed, which includes about 1 to about 15 percent by weight of the cerium oxide abrasive, and about 50 to about 1500 ppm of the at least one stabilizer.

In another preferred embodiment, the two-part article of manufacture comprises a first container, which includes at least one stabilizer dissolved in a first aqueous carrier, and which is packaged together with a second container including a particulate cerium oxide abrasive, preferably suspended in a second aqueous carrier. The cerium oxide abrasive is characterized by a mean particle size in the range of about 350 to about 900 nm, and the at least one stabilizer is selected from the group consisting of a polyvinylpyrrolidone, a poly(vinyl alcohol), a poly(2-ethyloxazoline), a hydroxyethyl cellulose, and a xanthan gum. Upon mixing the contents of the first container with the contents of the second container, a polishing composition of the invention is formed, which includes about 1 to about 15 percent by weight of the cerium oxide abrasive, and about 50 to about 1500 ppm of the at least one stabilizer.

Optionally, the first package of the two-part article of manufacture can include a water soluble inorganic salt (e.g., a cesium salt) at a concentration such that the mixed polishing composition includes about 0.05 to about 0.1 percent by weight of the salt. Preferably, the first and second aqueous carriers both comprise deionized water. The formulation and physico-chemical properties of the two aqueous carriers can be the same or different, as desired (e.g., the pH of each carrier can be the same or different, as needed or desired, and each carrier can contain various optional ingredients, such as solvents, biocides, buffer, surfactants, and the like, in the same or different amounts).

Preferred methods of the present invention comprise (i) contacting a glass substrate with a polishing pad and a polishing composition of the invention as described herein; and (ii) moving the polishing pad relative to the substrate with at least a portion of the polishing composition therebetween, thereby abrading at least a portion of the glass from the surface of the substrate to polish the substrate. Preferably, the glass substrate is an OLED or LCD-grade glass, such as a soda lime glass or an alkaline earth metal oxide-Al₂O₃—SiO₂ glass in which the alkaline earth oxide comprises one or more oxide selected from MgO, CaO, SrO, and BaO, which are well known in the art.

The polishing methods of the present invention are suitable for use in conjunction with a chemical-mechanical (CMP) polishing apparatus. Typically, the CMP apparatus comprises a platen, which, when in use, is in motion and has a velocity that results from orbital, linear, or circular motion. A polishing pad is mounted on the platen and moves with the platen. A carrier assembly holds a substrate to be polished. The polishing is accomplished by contacting the substrate with the pad while maintaining a potion of a polishing composition of the invention disposed between the pad and the substrate. The substrate is then moved relative to the surface of the polishing pad while being urged against the pad surface with a selected down force (preferably about 110 g/cm² or less) sufficient to achieve a desired glass removal rate. The polishing of the substrate is achieved through the combined chemical and mechanical action of the polishing pad and the polishing composition, which abrades the surface of the substrate.

A substrate can be planarized or polished with a polishing composition of the invention using any suitable polishing pad (e.g., polishing surface). Suitable polishing pads include, for example, fixed abrasive pads, woven pads, and non-woven pads. Moreover, suitable polishing pads can comprise any suitable polymer of varying density, hardness, thickness, compressibility, ability to rebound upon compression, and compression modulus. Suitable polymers include, for example, polyvinylchloride, polyvinylfluoride, nylon, fluorocarbon, polycarbonate, polyester, polyacrylate, polyether, polyethylene, polyamide, polyurethane, polystyrene, polypropylene, conformed products thereof, and mixtures thereof.

The following examples further illustrate the invention but, of course, should not be construed as in any way limiting its scope.

### Example 1

This example illustrates polishing of glass substrates according to the present invention utilizing aqueous polishing compositions comprising cerium oxide, with PVP as a stabilizer. Two polishing compositions of the invention (Composition 1A and 1B) were prepared. Composition 1A contained about 5 percent by weight of the cerium oxide abrasive, about 1000 ppm of PVP (K90), and about 1000 ppm of cesium chloride, in water at pH 5. Composition 1B contained about 5 percent by weight of cerium oxide abrasive (mean particle size of about 500 nm, purity greater than or equal to 99.9% CeO₂.), and about 1000 ppm of polyvinylpyrrolidone (K90) in water at pH 5. A comparative composition (Composition 1C) was also prepared, which contained about 5 percent of the cerium oxide abrasive in water without added salt or stabilizer.

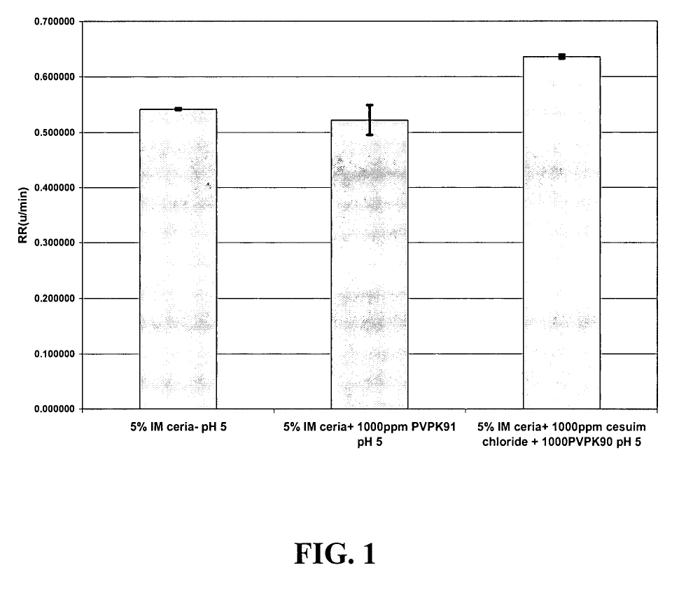

The three compositions were used to polish 4 cm-by-4 cm LCD-grade glass test panels (alkaline earth metal oxide (MgO, CaO, SrO, BaO)—Al₂O₃—SiO₂; Corning EAGLE® 2000) under the following polishing conditions: a down force of about 110 g/cm² (1.56 psi), a slurry flow rate of about 100 milliliters-per-minute (mL/min), a carrier speed of about 85 revolutions-per-minute (rpm), and a platen speed of about 100 rpm. The glass removal rates, in micrometers-per minute (μm/min), obtained with each composition are shown in FIG. 1. As the results in FIG. 1 indicate, Composition 1A provided an improvement of about 20 percent in the glass removal rate compared to the removal rate obtained using Composition 1C. In addition, Compositions 1A and 1B both provided improved handling characteristics (i.e., less settling in the delivery lines and slurry tank) compared to Composition 1C. In FIG. 1, the left bar represents the removal rate obtained with control Composition 1C, the middle bar represents the removal rate obtained with Composition 1B, and the right bar represents the removal rate obtained with Composition 1A.

### Example 2

This example illustrates polishing of glass substrates with a polishing composition according to the present invention. Polishing Composition 2A was prepared, which contained about 10 percent by weight of cerium oxide abrasive (mean particle size of about 500 nm), and about 1000 ppm of DAXAD® 32, an ammonium polymethacrylate stabilizer available from Hampshire Chemical Corp., Lexington Mass., in water at a pH of about 8.5. A control composition (Composition 2B) was also prepared, containing about 10 percent by weight of the cerium oxide abrasive in water at pH 8.5.

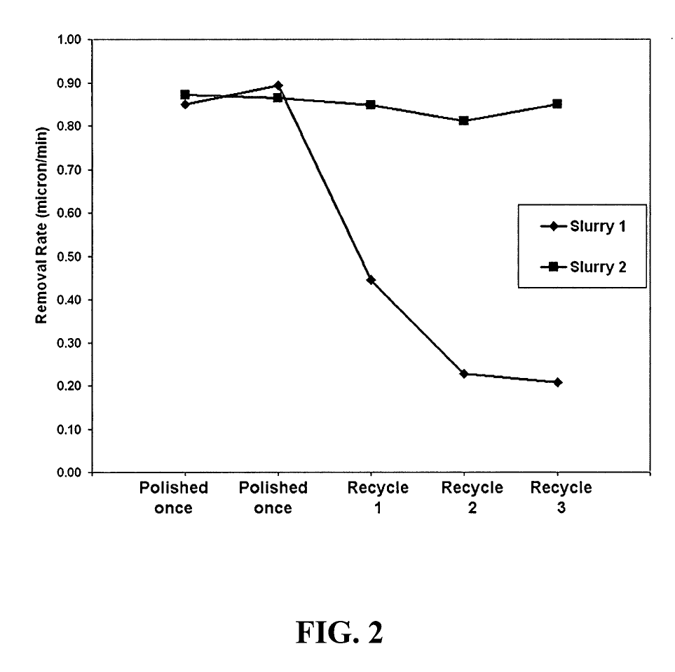

Compositions 2A and 2B were used to polish 4 cm-by-4 cm LCD-grade glass test panels (Corning EAGLE® 2000) under the following polishing conditions: a down force of about 110 g/cm², a slurry flow rate of about 100 mL/min, a carrier speed of about 85 rpm, and a platen speed of about 100 rpm. Each composition was used in two polishing runs as freshly prepared. Subsequently, an already used dispersion of Composition 2A was collected (recycled) and used in three additional polishing runs. A previously used dispersion of control composition 2B was also recycled in the same manner. The glass removal rates obtained with each composition in each polishing run are shown in FIG. 2, in which “Slurry 1” is the control (Composition 2B) and “Slurry 2” is Composition 2A. As the results in FIG. 2 demonstrate, Composition 2A provided consistently improved removal rates compared to the results obtained using Composition 2B, even after three reuses of the polishing composition. This indicates that the dispersion stability of the cerium oxide particles in the composition of the invention was significantly improved by the presence of the stabilizer compared to the control, which in turn prevented the removal rate from decreasing when recycled slurry was used.

### Example 3

This example illustrates polishing of glass substrates with polishing compositions of the present invention, in comparison to conventional cerium oxide-based polishing compositions having a purity of less than 99.9% CeO₂. The compositions evaluated in this Example all had a pH of about 8 to 9, and an abrasive concentration of 10% except for compositions 3G and 3H, which utilized 1% by weight of the abrasive. The compositions were used to polish 4 cm-by-4 cm LCD-grade glass test panels (Corning EAGLE® 2000) under the following polishing conditions: a down force of about 110 g/cm², a slurry flow rate of about 100 mL/min, a carrier speed of about 85 rpm, and a platen speed of about 100 rpm. The results are shown in Table 1. Compositions 3H, 3I and 3J are of the invention, while compositions 3A through 3G are comparative examples.

TABLE 1

| Composition | CeO₂ Purity | Mean Part. | Glass Removal Rate |
|---|---|---|---|
| (at pH 8-9) | (wt % CeO₂) | Size (μm) | (μm/min) |
| 3A | 79.9 | 1 | 0.5 |
| 3B | 49.6 | 4.7 | 0.4 |
| 3C | 50.6 | 3.3 | 0.38 |
| 3D | 55.1 | 3.7 | 0.26 |
| 3E | 75 | 0.6, 1.5, 3* | 0.4 |
| 3F | 85 | 1 | 0.5 |
| 3G | ≧99.9 | 0.08 | 0.1 (1% abrasive) |
| 3H | ≧99.9 | 0.22 | 0.37 (1% abrasive) |
| 3I | ≧99.95 | 10 | 0.8 |
| 3J | ≧99.95 | 0.5 | 0.8 |

*This material exhibited three peak values in the particle size distribution.

As the data in Table 1 show, Compositions 3I and 3J of the invention, which utilized highly pure cerium oxide, had a significantly higher glass removal rate compared to the control Compositions 3A through 3G. Similarly, Composition 3H of the invention, at about 1% abrasive concentration had a significantly higher removal rate compared to Composition 3G (also at 1% abrasive concentration), which has a mean particle size below 0.2 μm (e.g., 80 nm).

In a separate evaluation, 6 additional compositions of the invention were prepared, utilizing the same cerium oxide materials as Compositions 3I and 3J, at various abrasive concentrations and pH values (see Table 2). Compositions 3K through 3P were used to polish glass panels as described above for Compositions 3A through 3J, compared to results obtained with the same cerium oxide materials at pH of about 5 (Compositions 3S and 3T). Compositions 3O and 3P (of the invention) included 10 ppm and 5 ppm, respectively, of picolinic acid, as a stabilizer. The results are shown in Table 2.

TABLE 2

| Composition | CeO₂ Conc. | Mean Part. | Glass Removal Rate |
|---|---|---|---|
| (pH) | Wt % | Size μm | μm/min |
| 3K (8.5) | 10 | 0.5 | 0.7 |
| 3L (8.5) | 5 | 10 | 0.68 |
| 3M (8.5) | 5 | 0.5 | 0.62 |
| 3N (3.5) | 5 | 0.5 | 0.66 |
| 3O (3.5) | 1 | 0.5 | 0.52 (10 ppm picolinic acid) |
| 3P (3.5) | 1 | 0.5 | 0.55 (5 ppm picolinic acid) |
| 3R (3.5) | 1 | 0.5 | 0.3 |
| 3S (5) | 10 | 0.5 | 0.5 |
| 3T (5) | 10 | 10 | 0.5 |

As the results in Table 2 show, the compositions of the invention at pH 3.5 and 8.5 surprisingly outperformed comparative examples (3S and 3T) using 0.5 μm cerium oxide at pH 5, at both 5 and 10 concentrations of the cerium oxide. Similarly, Compositions 3O and 3P of the invention, which each had a cerium oxide concentration of about 1% at pH 3.5, and included added picolinic acid, surprisingly outperformed comparative Composition 3R, which also included 1% cerium oxide at pH 3.5, but without added picolinic acid.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A glass polishing method comprising abrading a surface of a glass substrate with an aqueous glass polishing composition for a period of time sufficient to remove at least a portion of the glass from the surface; wherein the polishing composition comprises about 1 to about 15 percent by weight of a particulate cerium oxide abrasive characterized by a mean particle size in the range of about 0.35 to about 0.9 μm, suspended in an aqueous carrier comprising about 50 to about 1500 parts-per-million (ppm) of a polymeric stabilizer.

2. The method of claim 1 wherein the polymeric stabilizer comprises at least one polymer selected from the group consisting of a polyacrylic acid, a polymethacrylic acid, a poly(vinyl sulfonic acid), a salt thereof, and a partially neutralized form thereof.

3. The method of claim 1 wherein the polymeric stabilizer comprises at least one polymer selected from the group consisting of a polyvinylpyrrolidone, a poly(vinyl alcohol), a poly(2-ethyloxazoline), a hydroxyethyl cellulose, and a xanthan gum.

4. The method of claim 1 wherein polishing composition further comprises a water soluble inorganic salt.

5. The method of claim 4 wherein the water soluble inorganic salt comprises about 0.5 to about 0.1 percent by weight of a cesium salt.

6. The method of claim 1 wherein the glass substrate comprises an alkaline earth metal oxide-Al₂O₃—SiO₂ glass in which the alkaline earth metal oxide comprises one or more oxide selected from the group consisting of MgO, CaO, SrO, and BaO.

7. A glass polishing method comprising the steps of:
(a) contacting a surface of a glass substrate with a polishing pad and an aqueous glass polishing composition at a down force of about 110 g/cm² or less; and
(b) causing relative motion between the polishing pad and the substrate while maintaining a portion of the composition in contact with the surface between the pad and the substrate for a time period sufficient to abrade at least a portion of the glass from the surface of the substrate;
wherein the polishing composition comprises about 1 to about 15 percent by weight of a particulate cerium oxide abrasive characterized by a mean particle size in the range of about 0.35 to about 0.9 μm, suspended in an aqueous carrier comprising about 50 to about 1500 parts-per-million (ppm) of a polymeric stabilizer.

8. The method of claim 7 wherein the polymeric stabilizer comprises at least one polymer selected from the group consisting of a polyacrylic acid, a polymethacrylic acid, a poly(vinyl sulfonic acid), a salt thereof, and a partially neutralized form thereof.

9. The method of claim 7 wherein the polymeric stabilizer comprises at least one polymer selected from the group consisting of a polyvinylpyrrolidone (PVP), a poly(vinyl alcohol), a poly(2-ethyloxazoline), a hydroxyethyl cellulose, and a xanthan gum.

10. The method of claim 11 wherein composition further comprises about 0.05 to about 0.1 percent by weight of a water soluble inorganic salt.

11. The method of claim 7 wherein the glass substrate comprises an alkaline earth metal oxide-Al₂O₃—SiO₂ glass in which the alkaline earth metal oxide comprises one or more oxide selected from the group consisting of MgO, CaO, SrO, and BaO.

12. A polishing composition comprising about 1 to about 15 percent by weight of particulate cerium oxide abrasive characterized by a mean particle size in the range of about 0.35 to about 0.9 μm, suspended in an aqueous carrier comprising about 50 to about 1500 ppm of a polymeric stabilizer.

13. The composition of claim 12 further comprising a water soluble inorganic salt.

14. The composition of claim 13 wherein the water soluble inorganic salt comprises a cesium salt.

15. The composition of claim 13 wherein the water soluble inorganic salt is present in the composition in an amount in the range of about 0.05 to about 0.1 percent by weight.

16. The composition of claim 12 wherein the polymeric stabilizer comprises at least one polymer selected from the group consisting of a polyacrylic acid, a polymethacrylic acid, a poly(vinyl sulfonic acid), a salt thereof, and a partially neutralized form thereof.

17. The composition of claim 12 wherein the polymeric stabilizer comprises at least one polymer selected from the group consisting of a polyvinylpyrrolidone, a poly(vinyl alcohol), a poly(2-ethyloxazoline), a hydroxyethyl cellulose, and a xanthan gum.

18. A two-part article of manufacture comprising a first container, which contains a polymeric stabilizer dissolved in a first aqueous carrier, packaged together with a second container, which contains a particulate cerium oxide abrasive suspended in a second aqueous carrier; wherein the cerium oxide abrasive is characterized by a mean particle size in the range of about 0.35 to about 0.9 μm; and wherein upon mixing the contents of the first container with the contents of the second container, a polishing composition is formed, which includes about 1 to about 15 percent by weight of the cerium oxide abrasive, and about 50 to about 1500 ppm of the polymeric stabilizer.

19. The article of manufacture of claim 18 wherein the polymeric stabilizer comprises at least one polymer selected from the group consisting of a polyacrylic acid, a polymethacrylic acid, a poly(vinyl sulfonic acid), a salt thereof, and a partially neutralized form thereof.

20. The article of manufacture of claim 18 wherein the polymeric stabilizer comprises at least one polymer selected from the group consisting of a polyvinylpyrrolidone, a poly(vinyl alcohol), a poly(2-ethyloxazoline), a hydroxyethyl cellulose, and a xanthan gum.

21. A glass polishing composition comprising about 1 to about 15 percent by weight of a particulate cerium oxide abrasive characterized by a mean particle size of at least about 0.2 μm and a purity of at least about 99.9% CeO₂, on a weight basis, suspended in an aqueous carrier at a pH at least about 1 unit higher or lower than the isoelectric point (IEP) of the cerium oxide abrasive.

22. The composition of claim 21 wherein the cerium oxide abrasive has a mean particle size in the range of about 0.2 to about 11 μm.

23. The composition of claim 21 wherein the pH is in the range of about 3 to about 4.

24. The composition of claim 23 further comprising about 1 to about 20 ppm of picolinic acid.

25. The composition of claim 21 wherein the pH is in the range of about 8 to about 9.

26. A glass polishing method comprising abrading a surface of a glass substrate with an aqueous glass polishing composition for a period of time sufficient to remove at least a portion of the glass from the surface; wherein the polishing composition comprises about 1 to about 15 percent by weight of a particulate cerium oxide abrasive characterized by a mean particle size of at least about 0.2 μm and a purity of at least about 99.9% CeO₂, on a weight basis, suspended in an aqueous carrier at a pH at least about 1 unit higher or lower than the isoelectric point (IEP) of the cerium oxide abrasive.

27. The method of claim 26 wherein the cerium oxide abrasive has a mean particle size in the range of about 0.2 to about 11 μm.

28. The method of claim 26 wherein the pH is in the range of about 3 to about 4.

29. The method of claim 28 wherein the composition further comprises about 1 to about 20 ppm of picolinic acid.

30. The method of claim 26 wherein the pH is in the range of about 8 to about 9.

31. The method of claim 26 wherein the glass substrate comprises an alkaline earth metal oxide-Al₂O₃—SiO₂ glass in which the alkaline earth metal oxide comprises one or more oxide selected from the group consisting of MgO, CaO, SrO, and BaO.

32. A glass polishing method comprising the steps of:
(a) contacting a surface of a glass substrate with a polishing pad and an aqueous glass polishing composition at a down force of about 110 g/cm² or less; and
(b) causing relative motion between the polishing pad and the substrate while maintaining a portion of the composition in contact with the surface between the pad and the substrate for a time period sufficient to abrade at least a portion of the glass from the surface of the substrate;
wherein the polishing composition comprises about 1 to about 15 percent by weight of a particulate cerium oxide abrasive characterized by a mean particle size of at least about 0.2 μm and a purity of at least about 99.9% CeO₂, on a weight basis, suspended in an aqueous carrier at a pH at least about 1 unit higher or lower than the isoelectric point (IEP) of the cerium oxide abrasive.

33. The method of claim 32 wherein the cerium oxide abrasive has a mean particle size in the range of about 0.2 to about 11 μm.

34. The method of claim 32 wherein the pH is in the range of about 3 to about 4.

35. The method of claim 34 wherein the composition further comprises about 1 to about 20 ppm of picolinic acid.

36. The method of claim 32 wherein the pH is in the range of about 8 to about 9.

37. The method of claim 32 wherein the glass substrate comprises an alkaline earth metal oxide-Al₂O₃—SiO₂ glass in which the alkaline earth metal oxide comprises one or more oxide selected from the group consisting of MgO, CaO, SrO, and BaO.
